(19) United States
(12) Patent Application Publication
(10) Pub. No.: US 2026/0053111 A1
(43) Pub. Date: Feb. 26, 2026

(54) PET HOUSE

(71) Applicant: Taizhou Sunup Tech.Co.,ltd, TAIZHOU ZJ (CN)

(72) Inventor: Xiangpeng CHEN, Taizhou (CN)

(21) Appl. No.: 18/933,886

(22) Filed: Oct. 31, 2024

(30) Foreign Application Priority Data
Aug. 21, 2024 (CN) 202422036269.7

(51) Int. Cl. A01K 1/015; A01K 1/00

(52) U.S. Cl. CPC A01K 1/0158; A01K 1/0052

(57) ABSTRACT

A pet house includes a bed base, a heat-conducting cover plate covered on the bed base, an electrical appliance cavity being formed between the bed base and the heat-conducting cover plate, a heat dissipation component fixed in the electrical appliance cavity, and a semiconductor refrigeration sheet one end of which cooperates with the heat dissipation component for heat transfer are fixed in the electrical appliance cavity, the other end of the semiconductor refrigeration sheet is in contact with the inner wall of the heat-conducting cover plate, and a lying pad for the pet to lie on is arranged directly above the heat-conducting cover plate. The semiconductor refrigeration sheet is electrified to enable the corresponding end face of the semiconductor refrigeration sheet which is jointed with the heat-conducting cover plate to refrigerate or heat, and the heat is transferred outwards to the lying pad by the heat-conducting cover plate.

### FIELD OF TECHNOLOGY

The patent belongs to the technical field of pet products, in particular to a pet house.

### TECHNICAL BACKGROUND

With the improvement of living standards, more and more people have pets, and in order to make the pets have a comfortable habitat in the room to maintain indoor hygiene, a pet bed is often placed, and the pets can rest on the pet bed. However, the existing pet beds are simple pads, and the pet beds cannot provide the pet with comfortable coolness or warmth in summer and winter.

### CONTENTS OF THE INVENTION

The patent aims to provide a pet house, wherein the pet house is cooled or heated by a semiconductor refrigeration sheet, and the heat is transferred outwards to a lying pad by means of a heat-conducting cover plate, so that the pet can obtain comfortable coolness or warmth on the lying pad.

The patent is realized as follows:

A pet house, comprising a bed base, a heat-conducting cover plate covered on the bed base, wherein an electrical appliance cavity formed between the bed base and the heat-conducting cover plate, a heat dissipation component fixed in the electrical appliance cavity, and a semiconductor refrigeration sheet one end of which cooperates with the heat dissipation component for heat transfer are fixed in the electrical appliance cavity, the other end of the semiconductor refrigeration sheet is in contact with the inner wall of the heat-conducting cover plate made of metal material, and a lying pad for the pet to lie on is arranged directly above the heat-conducting cover plate.

In the pet house, the lying pad is a condensation pad filled with condensate; or the lying pad is a cotton pad filled with cotton; or the lying pad is a leather pad or a fabric pad without filling.

In the pet house, the heat dissipation component comprises a heat dissipation fan and a heat dissipation plate, the top surface of the heat dissipation plate is jointed with the corresponding end surface of the semiconductor refrigeration sheet, the bottom surface of the heat dissipation plate is provided with heat dissipation fins, and the air outlet port of the heat dissipation fan is opposite to the position of the heat dissipation fins, and a ventilation port communicate with that outside is arranged on the bed base position in the electrical appliance cavity.

In the pet house, the ventilation port comprises an air inlet port and an air outlet port, wherein an air outlet channel communicated with the air outlet end of the heat dissipation fan and the air outlet port is enclosed by the inner wall surface of the bed base and a plurality of partition plates, the air inlet port and the air outlet port are separated inside and outside by the partition plates, and the air inlet end of the heat dissipation fan is communicated with the air inlet port.

In the pet house, the air outlet end of the heat dissipation plate is arranged upwards along the vertical direction, and a matching exhaust gap for exhausting air outwards towards the left side and the right side is formed between the air outlet end of the heat dissipation fan and the heat dissipation fins of the heat dissipation plate, wherein the air outlet channel and the air outlet port are both provided with two corresponding to the matching exhaust gap.

In the pet house, the air inlet end of the heat dissipation fan heat dissipation fan is arranged vertically downwards, and the inner wall surface of the bed base is provided with a raised annular protrusion which abuts against the outer edge of the air inlet end of the heat dissipation fan, wherein the side part of the raised annular protrusion is provided with a matching notch for communicating the air inlet end of the heat dissipation fan with the air inlet port.

In the pet house, a light strip is arranged on the outer wall surface of the bed base or the heat-conducting cover plate.

In the pet house, a control assembly is arranged in the electrical appliance cavity, wherein a control switch is arranged on the outer wall surface of the bed base, and the control switch, the semiconductor refrigeration sheet, the heat dissipation component and the light strip are all electrically connected with the control assembly, and the control assembly controls the on and off of the light strip, the semiconductor refrigeration sheet and the heat dissipation component according to the control switch.

In the pet house, the top surface of the heat-conducting cover plate is provided with an annular limiting protrusion, a limiting slot is defined between the annular limiting protrusion and the top surface of the heat-conducting cover plate, wherein the lying pad is placed on the limiting slot. In the pet house, a pet bed cover connected with the top surface of the bed base or the heat-conducting cover plate is arranged right above the heat-conducting cover plate, and the front side or the back side of the pet bed cover is an opening structure for the pet to get in and out.

Compared with the prior art, this patent has the following outstanding advantages:

This patent is featured with simple structure, reasonable design and low cost, wherein the semiconductor refrigeration sheet is electrified to enable the corresponding end face of the semiconductor refrigeration sheet which is jointed with the heat-conducting cover plate to refrigerate or heat, and the heat is transferred outwards to the lying pad by means of the heat-conducting cover plate, so that the pet can obtain comfortable coolness or warmth on the lying pad.

### DESCRIPTION OF FIGURES

FIG. 1 is the Overall Stereogram of the patent;

FIG. 2 is Section View I of the overall patent without a semiconductor refrigeration sheet and a heat dissipation component;

FIG. 3 is Section View II of the overall patent without a semiconductor refrigeration sheet and a heat dissipation component.

In the figures: 1. Bed base; 2. Heat-conducting cover plate; 3. Lying pad; 4. Air inlet port; 5. Air outlet port; 6. Partition plate; 7. Air outlet channel; 8. Raised annular protrusion; 9. Matching notch; 10. Annular limiting protrusion; 11. Pet bed cover.

### SPECIFIC EMBODIMENT

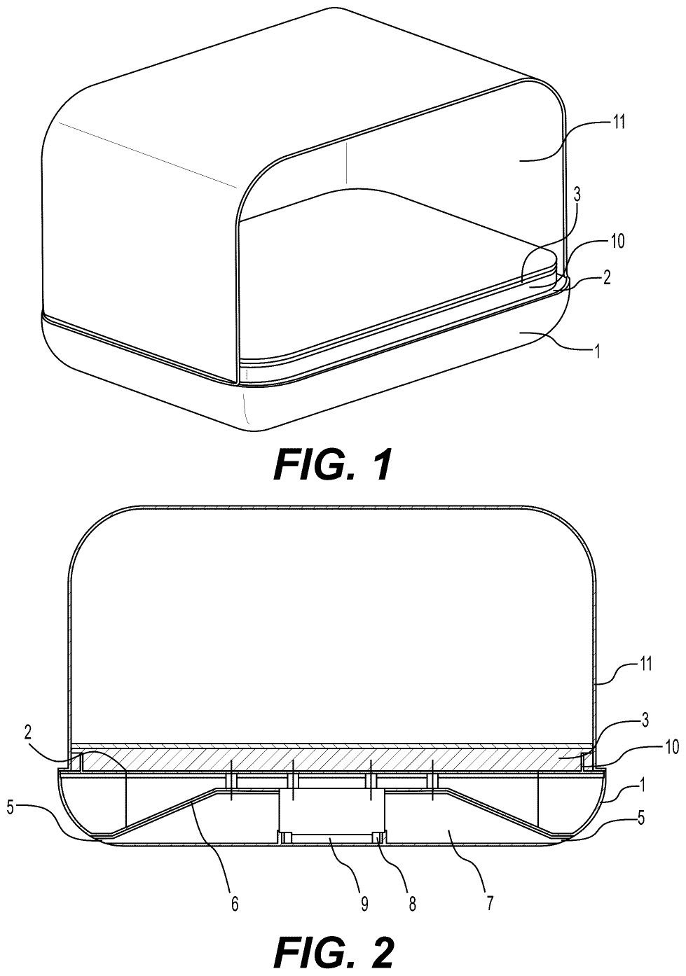

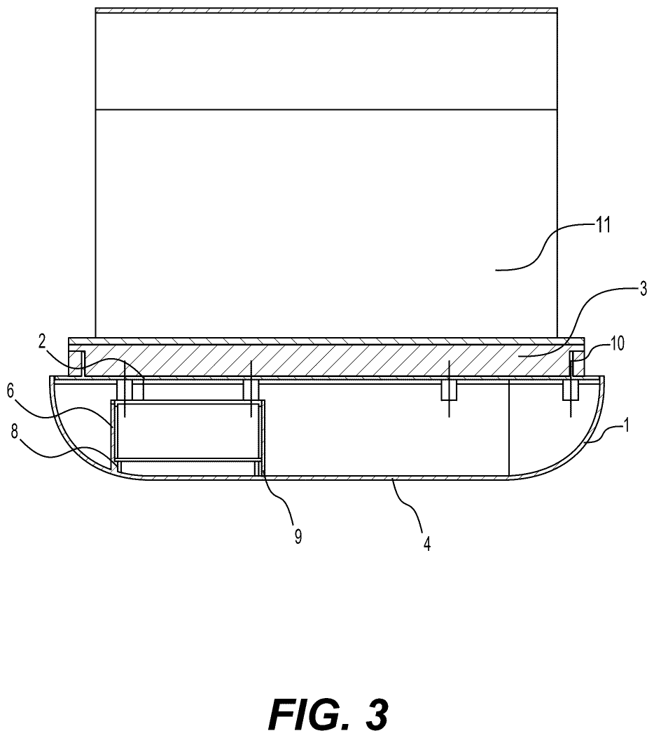

The patent is further described in the following specific embodiment, as shown in FIGS. 1-3:

A pet house, comprising a bed base 1, a heat-conducting cover plate 2 covered on the bed base 1, wherein an electrical appliance cavity formed between the bed base 1 and the heat-conducting cover plate 2, a heat dissipation component fixed in the electrical appliance cavity, and a semiconductor refrigeration sheet one end of which cooperates with the heat dissipation component for heat transfer are fixed in the electrical appliance cavity, the other end of the semiconductor refrigeration sheet is in contact with the inner wall of the heat-conducting cover plate 2 made of metal material, and a lying pad 3 for the pet to lie on is arranged directly above the heat-conducting cover plate 2. In this embodiment, the heat-conducting cover plate 2 is of an aluminum plate structure.

This patent is featured with simple structure, reasonable design and low cost, wherein the semiconductor refrigeration sheet is electrified to enable the corresponding end face of the semiconductor refrigeration sheet which is jointed with the heat-conducting cover plate 2 to refrigerate or heat, and the heat is transferred outwards to the lying pad 3 by means of the heat-conducting cover plate 2, so that the pet can obtain comfortable coolness or warmth on the lying pad 3.

In this embodiment, the lying pad 3 is a condensation pad filled with condensate, that is, the condensate, as a liquid medium, can effectively absorb the temperature transmitted from the heat-conducting cover plate 2 and uniformly distribute the temperature on the whole condensation pad;

Of course, according to the actual market demand, the lying pad 3 may also be a cotton pad filled with cotton inside, or the lying pad 3 is a leather pad or a fabric pad without filling.

Further, the matching structure of the semiconductor refrigeration sheet and the heat dissipation component can directly adopt the related structure on the market, and in this embodiment, the specific structure adopted by the heat dissipation component is as follows: the heat dissipation component comprises a heat dissipation fan and a heat dissipation plate, the top surface of the heat dissipation plate is jointed with the corresponding end surface of the semiconductor refrigeration sheet, the bottom surface of the heat dissipation plate is provided with heat dissipation fins, and the air outlet port of the heat dissipation fan is opposite to the position of the heat dissipation fins, and a ventilation port communicate with that outside is arranged on the bed base 1 position in the electrical appliance cavity.

In order to enable the air flow between the outside and the electrical appliance cavity to circulate, the ventilation port comprises an air inlet port 4 and an air outlet port 5, wherein an air outlet channel 7 communicated with the air outlet end 5 of the heat dissipation fan and the air outlet port is enclosed by the inner wall surface of the bed base 1 and a plurality of partition plates 6, the air inlet port 4 and the air outlet port 5 are separated inside and outside by the partition plates 6, and the air inlet end of the heat dissipation fan is communicated with the air inlet port 4.

Meanwhile, according to the matching structure between the heat dissipation fan and the heat dissipation plate, that is, the air outlet end of the heat dissipation plate is arranged upwards along the vertical direction, and a matching exhaust gap for exhausting air outwards towards the left side and the right side is formed between the air outlet end of the heat dissipation fan and the heat dissipation fins of the heat dissipation plate. Therefore, in order to enable the air outlet channel 7 to communicate with the air outlet end of the heat dissipation fin and the air outlet port 5, in this embodiment, the air outlet channel 7 and the air outlet port 5 are both provided with two corresponding to the matching exhaust gap.

Correspondingly, in order to extend the distance between the air inlet port 4 and the air inlet end of the heat dissipation fan, so that the air flow can flow in a large area in the electrical appliance cavity, then the air inlet end of the heat dissipation fan heat dissipation fan is arranged vertically downwards, and the inner wall surface of the bed base 1 is provided with a raised annular protrusion 8 which abuts against the outer edge of the air inlet end of the heat dissipation fan, wherein the side part of the raised annular protrusion 8 is provided with a matching notch 9 for communicating the air inlet end of the heat dissipation fan with the air inlet port 4.

Further, in order to enable the pet house to provide information such as identification guidance and the working state of an electrical appliance for a user, and to improve the ornamental value of the pet house, a light strip is arranged on the outer wall surface of the bed base 1 or the heat-conducting cover plate 2.

In order to improve the intelligent degree of the patent, a control assembly is arranged in the electrical appliance cavity, wherein a control switch is arranged on the outer wall surface of the bed base 1, and the control switch, the semiconductor refrigeration sheet, the heat dissipation component and the light strip are all electrically connected with the control assembly, and the control assembly controls the on and off of the light strip, the semiconductor refrigeration sheet and the heat dissipation component according to the control switch.

In addition, in order to enable the lying pad 3 to be stably placed on the heat-conducting cover plate 2, the top surface of the heat-conducting cover plate 2 is provided with an annular limiting protrusion 10, a limiting slot is defined between the annular limiting protrusion 10 and the top surface of the heat-conducting cover plate 2, wherein the lying pad 3 is placed on the limiting slot.

Furthermore, a pet bed cover 11 connected with the top surface of the bed base 1 or the heat-conducting cover plate 2 is arranged right above the heat-conducting cover plate 2, and the front side or the back side of the pet bed cover 11 is an opening structure for the pet to get in and out.

The embodiment above-mentioned is only one of the preferred embodiments of this patent, and does not limit the scope of implementation of this patent. Therefore, all equivalent changes made according to the shape, structure and principle of the patent shall be covered by the scope of protection of the patent.

1. A pet house, comprising a bed base, a heat-conducting cover plate covered on the bed base, wherein an electrical appliance cavity formed between the bed base and the heat-conducting cover plate, a heat dissipation component fixed in the electrical appliance cavity, and a semiconductor refrigeration sheet one end of which cooperates with the heat dissipation component for heat transfer are fixed in the electrical appliance cavity, the other end of the semiconductor refrigeration sheet is in contact with the inner wall of the heat-conducting cover plate made of metal material, and a lying pad for the pet to lie on is arranged directly above the heat-conducting cover plate.

2. The pet house according to claim 1, wherein the lying pad is a condensation pad filled with condensate; or the lying pad is a cotton pad filled with cotton; or the lying pad is a leather pad or a fabric pad without filling.

3. The pet house according to claim 1, wherein the heat dissipation component comprises a heat dissipation fan and a heat dissipation plate, the top surface of the heat dissipation plate is jointed with the corresponding end surface of the semiconductor refrigeration sheet, the bottom surface of the heat dissipation plate is provided with heat dissipation fins, and the air outlet port of the heat dissipation fan is opposite to the position of the heat dissipation fins, and a ventilation port communicate with that outside is arranged on the bed base position in the electrical appliance cavity.

4. The pet house according to claim 3, wherein the ventilation port comprises an air inlet port and an air outlet port, wherein an air outlet channel communicated with the air outlet end of the heat dissipation fan and the air outlet port is enclosed by the inner wall surface of the bed base and a plurality of partition plates, the air inlet port and the air outlet port are separated inside and outside by the partition plates (6), and the air inlet end of the heat dissipation fan is communicated with the air inlet port.

5. The pet house according to claim 4, wherein the air outlet end of the heat dissipation plate is arranged upwards along the vertical direction, and a matching exhaust gap for exhausting air outwards towards the left side and the right side is formed between the air outlet end of the heat dissipation fan and the heat dissipation fins of the heat dissipation plate, wherein the air outlet channel and the air outlet port are both provided with two corresponding to the matching exhaust gap.

6. The pet house according to claim 4, wherein the air inlet end of the heat dissipation fan heat dissipation fan is arranged vertically downwards, and the inner wall surface of the bed base is provided with a raised annular protrusion which abuts against the outer edge of the air inlet end of the heat dissipation fan, wherein the side part of the raised annular protrusion is provided with a matching notch for communicating the air inlet end of the heat dissipation fan with the air inlet port.

7. The pet house according to claim 1, wherein a light strip is arranged on the outer wall surface of the bed base or the heat-conducting cover plate.

8. The pet house according to claim 7, wherein a control assembly is arranged in the electrical appliance cavity, wherein a control switch is arranged on the outer wall surface of the bed base, and the control switch, the semiconductor refrigeration sheet, the heat dissipation component and the light strip are all electrically connected with the control assembly, and the control assembly controls the on and off of the light strip, the semiconductor refrigeration sheet and the heat dissipation component according to the control switch.

9. The pet house according to claim 1, wherein the top surface of the heat-conducting cover plate is provided with an annular limiting protrusion, a limiting slot is defined between the annular limiting protrusion and the top surface of the heat-conducting cover plate, wherein the lying pad is placed on the limiting slot.

10. The pet house according to claim 1, wherein a pet bed cover connected with the top surface of the bed base or the heat-conducting cover plate is arranged right above the heat-conducting cover plate, and the front side or the back side of the pet bed cover is an opening structure for the pet to get in and out.
